(19) United States
(12) Patent Application Publication
(10) Pub. No.: US 2023/0139317 A1
(43) Pub. Date: May 4, 2023

(54) SYSTEM AND METHOD FOR WIRELESS TRANSMISSION OF ENERGY

(71) Applicant: EnOcean GmbH, Oberhaching (DE)

(72) Inventors: Frank Schmidt, München (DE); Kazuyoshi Itagaki, Nagareyama, CHIBA (JP)

(21) Appl. No.: 17/910,916

(22) PCT Filed: Mar. 18, 2021
(86) PCT No.: PCT/EP2021/056979

§ 371 Date: Sep. 12, 2022

(30) Foreign Application Priority Data
Mar. 20, 2020 (DE) 102020107778.5

(51) Int. Cl. H02J 50/30; H02J 50/60; H02J 50/90; G02B 27/09

(52) U.S. Cl. CPC H02J 50/30; G02B 27/0927; H02J 50/60; H02J 50/90; G02F 2/00

(57) ABSTRACT

An energy transmission unit having a radiation source that generates an energy beam to transmit energy from the transmission unit to an energy receiving unit. The receiving unit includes an energy converter receiving an energy beam and converting it into electrical energy. When the energy transmission and receiving units are spatially aligned relative to one another, information is captured via markers or reflectors of the energy receiving unit about the presence of objects, humans or animals, or the position of the eyes of humans or animals. Defined criteria are checked on the basis of the captured information, and a radiation source of the energy transmission unit is aligned to a detected position of the energy receiving unit and activated, such that an energy beam is generated by the radiation source and energy of the energy beam generated by the radiation source can be received by the energy receiving unit.

The invention relates to an energy transmission unit and an energy receiving unit as well as a method for transmitting energy.

Today, the wireless transmission of energy is, for the most part, realized by magnetic fields (frequencies of approximately 100 KHz up to the 2-digit MHz range) or by radio waves (frequencies as of 100 MHz up to a few GHz). This technology is generally sophisticated and there any many commercially available solutions.

In addition, some apparatuses and methods have already been described, which transmit energy by means of optical radiation in the visible range or close to the visible range, wherein coherent radiation from LASER sources is in particular proposed, which can bridge large distances due to the low beam divergence.

However, the previous solutions do have a number of disadvantages. On the one hand, they comprise dangerous levels of energy or a high energy density per area. The transmission of energy by means of electromagnetic radiation in the visible or invisible spectrum requires, for safety reasons, for humans, animals and, in particular, in order to protect the eyes, that legally specified limits for the maximum energy density per area are not exceeded. However, proposed solutions frequently work with high levels of energy per unit area, in particular when phase-coherent radiation sources (LASER) are used. This is known, e.g., from the publication “Concepts for wireless energy transmission via laser, Leopold Summerer, Oisin Purcell, ESA - Advanced Concepts Team Keplerlaan 1, NL-2201AZ Noordwijk, The Netherlands, Leopold.Summerer@esa.int, |31-71-565-6227)”. The fundamentals of transporting energy by means of laser between the Earth and the orbit close to Earth are discussed in this scientific publication.

Various methods have been proposed to date in order to protect humans and animals from high energy densities. For the most part, these methods work with various laser intensities, wherein work is initially carried out with small intensities until the energy transmission is established and it is then constantly tested by means of feedback from the consumer as to whether the energy beam has been interrupted. Use is then made of this criterion to quickly reduce the power. In these cases, constant and active feedback from the receiver is required, which is provided, by way of example, on a return channel by means of radio transmission. This likewise requires an energy outlay which has to be expended by the energy to be transmitted.

A further disadvantage of conventional solutions is the very small areas which necessitate a high positioning accuracy. Typically, work is carried out with LASER sources which have very small cross-sections of the energy beam. This results in a high positioning accuracy of the energy source being required in the case of moving consumers, which is correspondingly difficult to achieve. That is to say that a constant, active feedback is also required here in order to track positions. This process also requires energy which has to be mustered by the transmitted energy and is therefore not available for the actual purpose of supplying a device.

A further disadvantage of conventional solutions is that a receiver always has to have a minimum amount of energy available when the method is started in order to be able to even start the energy transmission process. If the energy store of a consumer is empty, the energy transmission cannot be started.

It is therefore an object of the present invention to describe an energy transmission unit, an energy receiving unit as well as a method for transmitting energy which overcome the indicated disadvantages of conventional approaches.

This object is initially achieved by an energy transmission unit according to Claim 1. Further embodiments and implementations are disclosed in the associated subclaims. The energy transmission unit has a radiation source which is adapted to generate an energy beam in order to transmit energy from the energy transmission unit to an energy receiving unit.

In various alternative or additional embodiments and/or further developments of the energy transmission unit, the radiation source is adapted to radiate phase-coherent light (laser) in the invisible or visible range.

In various alternative or additional embodiments and/or further developments of the energy transmission unit, the latter has a unit for beam shaping which is adapted to convert or to shape the energy beam of the radiation source, in particular by means of optical elements, into a shaped energy beam.

In various alternative or additional embodiments and/or further developments of the energy transmission unit, the latter has a mechanical actuator which is adapted to control the direction of the energy beam or of the shaped energy beam.

In various alternative or additional embodiments and/or further developments of the energy transmission unit, the latter has multiple radiation sources and non-mechanical control means which are adapted to control the direction of the energy beam or of the shaped energy beam by superposing the multiple radiation sources.

In various alternative or additional embodiments and/or further developments of the energy transmission unit, the latter has non-mechanical control means which are adapted to control the direction of the energy beam or of the shaped energy beam by controlling or influencing a refractive index in optical media.

In various alternative or additional embodiments and/or further developments of the energy transmission unit, the latter has a receiver which is adapted to receive and evaluate energy beam proportions reflected from the surroundings of the energy transmission unit.

In various alternative or additional embodiments and/or further developments of the energy transmission unit, the receiver is embodied as a demodulator or has a demodulator which is adapted to receive and to demodulate energy beam proportions reflected and modulated from the surroundings of the energy transmission unit.

In various alternative or additional embodiments and/or further developments of the energy transmission unit, the latter has a camera which is adapted to acquire or to capture images or image information of the surroundings of the energy transmission unit.

In various alternative or additional embodiments and/or further developments of the energy transmission unit, the latter has implemented algorithms of a pattern recognition for evaluating images or image information which have/has been acquired or captured by means of a camera.

In various alternative or additional embodiments and/or further developments of the energy transmission unit, the algorithms of the pattern recognition are stored in the form of one or more executable programs or software within the energy transmission unit.

In various alternative or additional embodiments and/or further developments, the energy transmission unit is adapted to carry out the following measures of:
capturing at least the following information by the camera:
presence and position of markers or reflectors of an energy receiving unit,
position of the eyes of humans and/or animals,
checking the presence of the markers or reflectors of the energy receiving unit and a sufficient safety distance between the position of an energy converter of the energy receiving unit and the eyes of humans and/or animals as required criteria,
provided that these required criteria are met, aligning the radiation source of the energy transmission unit to a detected position of the energy receiving unit and activating the radiation source, such that an energy beam is generated by the radiation source.

Furthermore, the above object is achieved by an energy receiving unit according to Claim 10. Further embodiments and implementations are disclosed in the associated subclaims. The energy receiving unit has an energy converter which is adapted to receive energy of an energy beam of an energy transmission unit and to convert said energy into electrical energy. The energy transmission unit corresponds, for example, to an energy transmission unit of the type explained above.

In various alternative or additional embodiments and/or further developments of the energy receiving unit, the latter has one or more reflectors which are arranged close to or in the vicinity of the energy converter and are adapted to reflect the energy beam of the energy transmission unit at least partially.

In various alternative or additional embodiments and/or further developments of the energy receiving unit, a plurality of reflectors is adapted, which reflectors are arranged surrounding the energy converter, in particular in a circular manner.

In various alternative or additional embodiments and/or further developments of the energy receiving unit, the reflector(s) is/are adapted in such a way that the reflectance thereof can be electrically controlled or modulated.

In various alternative or additional embodiments and/or further developments of the energy receiving unit, the reflector(s) is/are adapted as controllable LCD elements for controlling or modulating the reflectance thereof.

In various alternative or additional embodiments and/or further developments of the energy receiving unit, the latter has an element which is adapted to control or modulate the reflectance of the reflectors.

In various alternative or additional embodiments and/or further developments of the energy receiving unit, the latter has one or more optical markers which, due to their mechanical shape, color(s), printing with patterns and/or digital codes, reflectors (static or modulatable) and/or, due to the use of light sources (invisible or visible spectrum), are configured to identify a location, orientation and/or position of the energy receiving unit in the space.

The above object is, furthermore, achieved by a system according to Claim 15. The system comprises an energy transmission unit of the type explained above and an energy receiving unit of the type explained above. The energy transmission unit and the energy receiving unit are or can be spatially aligned relative to one another in such a way that energy can be transmitted by the energy transmission unit to the energy receiving unit by means of an energy beam generated by the energy transmission unit. The energy can be received by the energy receiving unit and converted into electrical energy.

The above object is, furthermore, achieved by a method for transmitting energy according to Claim 16. Further embodiments and implementations are disclosed in the associated subclaims.

The method is implemented for transmitting energy between an energy transmission unit and an energy receiving unit, which are or can be spatially aligned relative to one another.

The method comprises the following steps of:
capturing at least one of the following items of information by a camera of the energy transmission unit:
presence and position of markers or reflectors of the energy receiving unit,
presence of objects, humans or animals,
position of the eyes of humans and/or animals,
checking defined criteria on the basis of the captured information, in particular the presence of the markers or reflectors of the energy receiving unit and/or a sufficient safety distance between the position of an energy converter of the energy receiving unit and the eyes of humans and/or animals,
provided that all the required criteria are met, aligning a radiation source of the energy transmission unit to a detected position of the energy receiving unit and activating the radiation source, such that an energy beam is generated by the radiation source,
receiving energy of the energy beam generated by the radiation source by the energy receiving unit,
converting the received energy into electrical energy by means of the energy converter of the energy receiving unit.

In various alternative or additional embodiments and/or further developments of the method, checking of the defined or required criteria is continued as long as a sufficient number of criteria are not met.

In various alternative or additional embodiments and/or further developments of the method, checking of the defined or required criteria is continued periodically in a predefined time interval. The time interval or a time criterion is predefined in such a way that
a) the positions of the objects, humans or animals have not yet significantly altered in the space, and/or
b) due to the shortness of time, no hazardous exposure, in particular of the eyes, can take place in the energy beam.

In various alternative or additional embodiments and/or further developments of the method, after the radiation source has been activated, the latter is deactivated or the power thereof is reduced, if checking of the defined or required criteria reveals that a sufficient number of criteria are no longer met.

In various alternative or additional embodiments and/or further developments of the method, the energy beam is converted or shaped into a shaped energy beam by means of a unit for beam shaping.

In various alternative or additional embodiments and/or further developments of the method, a direction of the energy beam or of the shaped energy beam is controlled by means of a mechanical actuator and/or by means of non-mechanical control means.

In various alternative or additional embodiments and/or further developments of the method, energy of the energy beam is reflected by reflectors of the energy receiving unit. These reflections are received and evaluated by a receiver of the energy transmission unit.

In various alternative or additional embodiments and/or further developments of the method, the reflectors of the energy receiving unit modulate the reflections. The receiver works as a demodulator and receives and demodulates the modulated reflections.

In various alternative or additional embodiments and/or further developments of the method, a direction of the energy beam or of the shaped energy beam is continually readjusted based on the evaluated reflections.

The invention achieves the object of wirelessly supplying electronic devices with energy, wherein electromagnetic radiation is in particular to be used to transmit the energy. The applications to be operated therewith include, by way of example, mobile or movable devices such as portable input devices, controllers, cell phones and mobile computers, as well as hearing aids, clothing having electronic functions, as well as devices such as check cards, electronic labels and radio sensors which measure parameters from the surroundings and transmit via radio. Similarly, applications are, however, also permanently installed devices with movable or immovable parts such as electronically controlled door locks, sensors and actuators of building automation, in rail and road vehicles, in production or in medical technology or on structures such as, e.g., buildings, tunnels, dams and bridges.

In contrast to solutions from the prior art, the invention relates to the transmission of energy at significantly higher frequencies, specifically in the optical wavelength range from approximately 100 nm to 10 µm, which includes the visible spectrum as well as ranges above and below it.

Some features are listed below, which are enlisted in various implementations or further developments of the invention as an alternative or in addition, on their own or in combination with other features or implementations.
1. A method for transmitting energy by means of directed electromagnetic radiation, essentially comprising/consisting of a radiation source and a radiation receiver which converts the emitted electromagnetic radiation into electrical energy, 2. Use of coherent radiation,
3. Use of non-coherent radiation,
4. Beam shaping in order to achieve an uncritical energy density per area through lenses or mirrors,
5. Alignment of the energy beam through movable or deformable lenses or mirrors or a movable radiation source,
6. Use of a receiver on the laser which can receive and demodulate backscattered radiation proportions from the surroundings,
7. Use of at least one camera which works with image recognition algorithms (KI) which are adapted to recognize people and animals and to recognize and track the position of the eyes and are, furthermore, suitable for recognizing optical markers,
8. Use of optical markers on the receiver of the energy: color markings, light-emitting diodes, special shapes or a combination thereof,
9. Use of a photovoltaic cell for converting the radiation energy into electrical energy,
10. Use of reflectors on the receiver of the energy, the reflectance of which reflectors can be modulated, e.g., formed by electrically controllable LCD elements,
11. Arrangement of the modulatable reflectors around the photovoltaic cell,
12. Energy supply also from several or many receivers having one source.

All of the structural features of the energy transmission unit or energy receiving unit explained above or of the system explained above can manifest themselves in corresponding method steps or measures and vice versa.

The invention will be explained in greater detail below on the basis of exemplary embodiments, with the aid of multiple drawings, wherein:

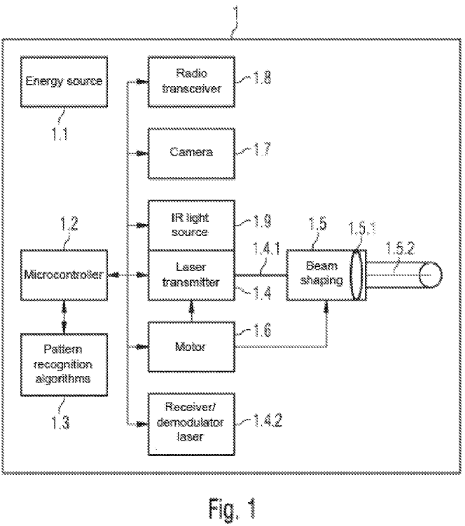

FIG. 1 shows a block diagram of an energy transmitter,

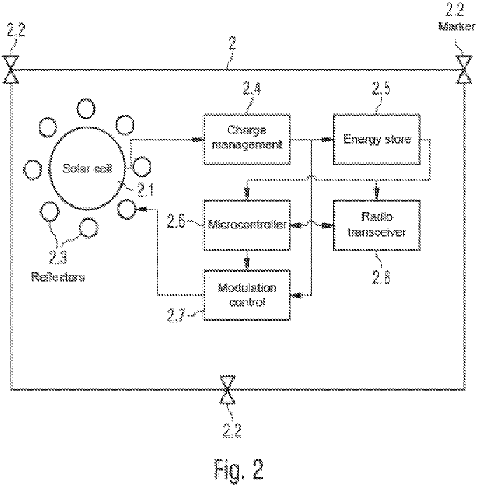

FIG. 2 shows a block diagram of an energy receiver,

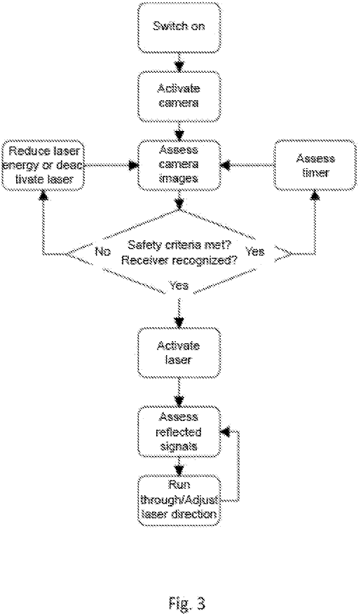

FIG. 3 shows a flow chart of a method for transmitting energy, and

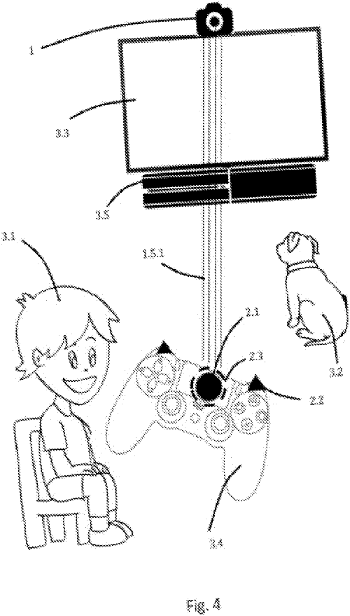

FIG. 4 shows a schematized spatial arrangement, using the example of a game controller or a game system.

FIGS. 1 and 2 illustrate essential components in a system for the wireless transmission of energy.

FIG. 1 shows a block diagram of an energy transmitter 1. FIG. 1 shows a transmitter side of the energy transmission. An energy source 1.1 supplies the electrical operating energy for all of the components. The energy source 1.1 is formed, for example, by the local power supply system. However, depending on the specific application, batteries, power generators or ambient energy such as, for instance, solar energy or wind energy, is/are alternatively or additionally used as the energy source 1.1.

Furthermore, an essential element is a radiation source 1.4 which preferably radiates phase-coherent light (laser) in the invisible or visible range. Semiconductor lasers or other, non-coherent semiconductor light sources are preferably used. A unit for beam shaping 1.5 is connected to the radiation source/laser apparatus 1.4. This has the task/function, for example, of lowering the energy density to a level which is not hazardous to the human eye by shaping the energy beam 1.4.1 of the radiation source 1.4 by means of optical elements 1.5.1, such as fixed lenses, deformable lenses or mirrors or a combination of these components to produce a shaped beam 1.5.2 such that the energy which can strike, e.g., the surface of the human pupil, is harmless to the latter at least for short periods of time. Here, a shaping of the energy beam 1.4.1 into the shaped beam 1.5.2 by means of the beam shaping 1.5 comprises, for example, a beam widening, broadening or scattering. In alternative implementations, the shaping of the energy beam 1.4.1 into the shaped beam 1.5.2 by means of the beam shaping 1.5 comprises, for example, a beam narrowing, concentration or bundling.

At the same time, as a second condition, the energy beam is shaped such that the latter has the best possible superposition when it strikes an energy converter 2.1 of the receiver 2 (see FIG. 2). This can be applied not only when using coherent radiation, but also with non-coherent radiation and is an essential element of the solution presented.

Part of an (optionally) implemented safety apparatus is protection against dismantling of the laser apparatus 1.4 or destruction/demounting of the beam shaping 1.5 or 1.5.1. This is achieved, for example, by sensors or by an interrupting power supply line which deactivate(s) the laser 1.4 when dismantled and therefore prevent(s) the leakage of impermissible power levels 1.4.1.

In this exemplary embodiment, part of the laser apparatus 1.4 is also a receiver/demodulator 1.4.2 for radiation of the same wavelength, which can receive and demodulate the proportions reflected from the surroundings.

A further element is a mechanical actuator or motor 1.6 which can control the direction of the energy beam 1.4.1 or 1.5.2. To this end, e.g., electric motors or piezo motors can be used, which act on the radiation source 1.4 or the optical elements 1.5 or 1.5.1 or on both. Furthermore, non-mechanical controls of the energy beam can be used, which work with the control of the direction by superposing multiple radiation sources or with the control of the refractive index in optical media.

A further element of this embodiment is a camera 1.7 which acquires images of the surroundings. The surroundings can optionally be illuminated with an infrared light source 1.9 if the ambient light is not sufficient. A further optional element is a radio transceiver 1.8 which can send and receive information.

In particular, in this exemplary implementation, algorithms of the pattern recognition 1.3 are also used in order to evaluate the images which the camera 1.7 acquires of the surroundings, if necessary utilizing the infrared light source 1.9. The algorithms of the pattern recognition 1.3 are stored, for example, in the form of executable programs or software.

A further essential element is a microcontroller 1.2 which here, by way of example, performs all the tasks of regulating and controlling the individual components or of executing programs or software and can, in particular, process data streams from the camera 1.7, the radio transceiver 1.8 and the backscattered signals of the laser from the demodulator 1.4.2. The microcontroller is, for example, also adapted to execute the algorithms of the pattern recognition 1.3.

The algorithms of the pattern recognition 1.3 are, for example, constructed such that
a) humans and pets can be distinguished from the surroundings and/or
b) in particular, the position of the eyes can be identified and/or
c) markers located on the receiver device (see FIG. 2) can be recognized.

FIG. 2 shows essential elements of the energy receiver 2. Thus, 2.1 is an energy converter which converts the received radiation (the received energy beam 1.4.1 or 1.5.2) into electrical energy. Photovoltaic cells which are optimized for the wavelength of the radiation, e.g., GaAS solar cells which have been optimized for wavelengths of 850 nm, can preferably be used for this.

Reflectors 2.3, the reflectance of which can be electrically controlled or modulated, are optionally arranged in the vicinity of the energy converter 2.1. This is possible, e.g., in a particularly energy-saving way thanks to LCD elements. In the exemplary embodiment according to FIG. 2, the energy converter 2.1 is circular, wherein a plurality of reflectors 2.3 are arranged surrounding the energy converter 2.1 in a circular manner. Alternative arrangements of the reflectors 2.3 are provided in other implementations.

A further element are optical markers 2.2 which are located on the device 2 and which can be easily identified by the remote camera 1.7 of the energy transmitter 1 (see FIG. 1 and explanations above). These markers 2.2 can be configured by their mechanical shape, colors, printing with patterns and/or digital codes, reflectors (static or modulatable) and/or by the use of light sources (invisible or visible spectrum).

An electronic circuit 2.4, which takes over the charge management of an energy store 2.5, is assigned to the energy converter 2.1. In this embodiment, this energy store 2.5 forms the essential energy source for the device to be operated and equipped with the radiation receiver/energy receiver 2, which device has additional functions to collecting energy. Furthermore, in the depicted embodiment, there is an element 2.7 which controls the modulation of the reflectors 2.3 as soon as radiation strikes the energy converter 2.1. In this example, the element 2.7 is a dedicated electronic circuit 2.7 which offers the advantage of particularly low current consumption and also functions with an empty energy store 2.5 and, if necessary, without the use of a microcontroller/controller 2.6 as soon as energy arrives at the solar cell/energy converter 2.1. In alternative implementations, this function of the element 2.7 is assumed by the microcontroller 2.6. The element 2.7 can be dispensed with.

Furthermore, the energy receiver 2 has a radio transceiver 2.8 which can exchange data with the transceiver 1.8 of the energy transmitter 1 (see FIG. 1 and the above explanations).

FIG. 3 shows a flow chart of a method for transmitting energy. The essential steps illustrated are typically run through, e.g., when operating a system made up of an energy transmitter 1 (see FIG. 1) and an energy receiver 2 (see FIG. 2) of the type explained above.

When the energy transmitter 1 is switched on, the camera 1.7 is initially activated. This supplies images from the surroundings, which are analyzed with the aid of the image processing algorithms 1.3. The following information is in particular obtained:
presence and position of the markers 2.2 or reflectors 2.3,
presence of humans or animals,
position of the eyes of humans or animals.

A set of criteria which have to be met before the laser 1.4 can be activated is then checked. These criteria include at least the presence of the markers 2.2 and a sufficient safety distance between the position of the energy converter/solar cell 2.1 of the energy receiver 2 and the eyes of humans and animals.

If a sufficient number of criteria are not met, the check of the camera images is continued. Modified algorithms 1.3 can also be used, which allow objects, once they have been identified, to be tracked as they move in the space.

The check of the criteria is continued periodically, regardless of the result, wherein a time criterion guarantees that a) the positions of the objects in the space cannot have yet altered significantly, and/or b) due to the shortness of time, no hazardous exposure, in particular of the eyes, can take place.

As soon as all of the necessary criteria are met, the laser 1.4 is directed at the position established by the markers 2.2 and activated. The modulatable reflectors 2.3, which surround the energy converter 2.1 of the energy receiver 2, reflect the energy beam 1.4.1 or 1.5.2 as soon as they are struck by the latter. These reflections are received and evaluated by the receiver of the reflected proportions, e.g., in particular component 1.4.2, which is structurally arranged in the vicinity of the transmitter (laser 1.4) and the camera 1.7. It is now possible to extrapolate the precise superimposition of the energy beam 1.4.1 or 1.5.2 with the energy converter 2.1. This information is utilized for the continual readjustment of the direction of the energy beam 1.4.1 or 1.5.2 by the beam control of the transmitter (laser 1.4). The beam is controlled, e.g., via the component 1.6 and/or the component 1.5.

If, due to a possible inaccuracy of the method of the optical markers 2.2 or reflectors 2.3, no reflected proportions with the corresponding modulation arrive, the closer environment of the calculated position of the energy converter 2.1 can be scanned with the energy beam 1.4.1 or 1.5.2, until corresponding modulations appear and indicate the exact position.

The use in various applications is described below. I. Sample application of a game controller:

FIG. 4 illustrates one sample application of the components, systems and methods explained above on the basis of a game controller. FIG. 4 illustrates the general spatial arrangement of the components using the sample application of energy transmission for a game controller 3.4 which controls a game console 3.5, the images of which are displayed on a screen 3.3.

In this case, essential parts of the energy transmitter/the energy transmission apparatus 1 are accommodated here, by way of example, in the vicinity of the screen 3.3, but can in general also be integrated into other devices such as the game console 3.5 or the screen 3.3.

In this example, the energy transmission apparatus 1 has the functional blocks described in more detail in FIG. 1 and explained above, the camera (see 1.7 in FIG. 1) and radiation source (see 1.4/1.5 in FIG. 1) visible here in FIG. 4, which emits and aligns the (shaped) energy beam 1.4.1 or 1.5.1. The position of humans 3.1, pets 3.2 and, in particular, of their eyes is recognized and taken into account with the described method. The position of the eyes is important because, in principle, an energy beam 1.4.1 or 1.5.1 of a non-hazardous power density can also be bundled by optical aids such as lenses, mirrors, telescopes, etc. at high surface powers. Even if, for example, a person were looking into the radiation source with binoculars and their eyes were covered, their position in relation to the body can be recognized or known with the above measures and features, and the energy transmission apparatus 1 can prevent energy being emitted.

In this example, the game controller 3.5 is the energy-receiving device 2. It has markers 2.2 affixed to the outside which, due to their particularly high contrast, can be recognized easily and extremely accurately by the image recognition algorithms 1.3 of the energy transmitter 1. This allows a quick and precise localization of the game controller 3.5 in the plane/space. Furthermore, it is possible, for example, by evaluating the transit time of short light pulses or by utilizing differently/variably modulated light, to determine the distance between the markers 2.2 and the camera 1 (see 1.7 in FIG. 1).

As described, after recognizing the people 3.1 and pets 3.2 and their eyes and checking a list of safety criteria, the energy transfer can be started, wherein the energy beam 1.4.1 or 1.5.2 strikes the photovoltaic cell/energy converter 2.1 and the exact alignment of the energy beam 1.4.1 or 1.5.2 can be readjusted by evaluating the proportions of the energy beam 1.4.1 or 1.5.2 modulated by the reflectors 2.3 (see FIG. 2 and the explanations above). Compared with the evaluation of the position by the camera 1 (see 1.7 in FIG. 1), this evaluation is significantly quicker and also allows rapid movements of the controller 3.4 to be followed without the energy supply being interrupted.

II. Sample application of energy supply of radio sensors and actuators:
Further sample applications of the components, systems and methods explained above are explained below.
Radio sensors and radio actuators which transmit their data or action commands via radio are already widely used today. The energy supply is a critical point, in particular when battery changes are expensive (difficult access) or no ambient energy is available (in particular only insufficient light).

Examples are:
Radio sensors in tunnels, which measure structural parameters, temperature, humidity, air quality and monitor traffic;
Radio sensors on moving or rotating machine parts, which measure, e.g., forces, torque, distance, temperatures;
Radio sensors which monitor and report on the level of goods in production logistics or warehousing, e.g., by tracking carriers for goods on assembly lines or in high-bay warehouses;
Radio sensors which are mounted on vehicles such as cars or rail vehicles, and which are supplied with energy by stationary energy transmitters, and then make data regarding the identity and condition of the transport vehicles readable as they drive past;
Sensors on aircraft, which, e.g., help to obtain safety-relevant measured values from the inner wings, thereby saving cables/weight.
Radio sensors/radio actuators which process access information and/or lock/unlock access systems. This means, by way of example, radio sensors in doors which, on the one hand, report on the status of the door (open, closed, locked), but can also be instructed via radio to lock or unlock a door by means of electromechanical actuators.

III. Sample application of energy supply of mobile devices: Further sample applications of the components, systems and methods explained above are explained below.

Cell phones, mobile computers and similar devices can be charged with the components, systems and methods described above, without cables having to be plugged in and/or without the need for precise positioning on, e.g., charging pads or charging docks. To this end, the energy transmitter 1 can be affixed to the ceiling centrally in rooms.

IV. Sample application of an energy supply for portable devices (wearables):

Further sample applications of the components, systems and methods explained above are explained below.

Wearable devices (wearables) such as fitness trackers, medical devices, smartwatches, hearing aids, electronic spectacles having a video function, virtual reality glasses or electronics which are connected to the clothing can be supplied with energy with the components, systems and methods described above. This is possible in a particularly feasible manner if an infrastructure is installed on energy transmitters 1 at the locations where this utilization is necessary or particularly likely.

The depicted embodiments are merely selected as examples.

1. An energy transmission unit, having:
a radiation source configured to generate an energy beam in order to transmit energy from the energy transmission unit to an energy receiving unit,
a camera configured to acquire or to capture images or image information of the surroundings of the energy transmission unit, and
implemented algorithms of a pattern recognition for evaluating images or image information which have/has been acquired or captured by the camera,
wherein the energy transmission unit is configured to carry out the following measures of:
capturing at least the following information by the camera:
presence and position of markers or reflectors of an energy receiving unit,
position of the eyes of humans and/or animals,
checking the presence of the markers or reflectors of the energy receiving unit (2) and a sufficient safety distance between the position of an energy converter of the energy receiving unit and the eyes of humans and/or animals as required criteria,
provided that these required criteria are met, aligning the radiation source of the energy transmission unit to a detected position of the energy receiving unit (2) and activating the radiation source, such that an energy beam is generated by the radiation source.

2. The energy transmission unit according to claim 1, wherein the radiation source is configured to reflect phase-coherent light (laser) in the invisible or visible range.

3. The energy transmission unit according to claim 1, further having a unit for beam shaping which is configured to convert or to shape the energy beam of the radiation source, via optical elements, into a shaped energy beam.

4. The energy transmission unit according to claim 1, further having a mechanical actuator configured to control the direction of the energy beam or of the shaped energy beam.

5. The energy transmission unit according to claim 1, further having multiple radiation sources and non-mechanical control means to control the direction of the energy beam or of the shaped energy beam by superposing the multiple radiation sources.

6. The energy transmission unit according to claim 1, further having non-mechanical control means to control the direction of the energy beam or of the shaped energy beam by controlling or influencing a refractive index in optical media.

7. The energy transmission unit according to claim 1, further having a receiver to receive and evaluate energy beam proportions reflected from the surroundings of the energy transmission unit.

8. The energy transmission unit according to claim 7, wherein the receiver is embodied as a demodulator or has a demodulator to receive and to demodulate energy beam proportions reflected and modulated from the surroundings of the energy transmission unit.

9. The energy transmission unit according to claim 1, wherein the algorithms of the pattern recognition are stored in the form of one or more executable programs or software within the energy transmission unit.

10. An energy receiving unit (2), having:
an energy converter configured to receive energy of an energy beam of an energy transmission unit and to convert said energy into electrical energy,
one or more reflectors which are arranged close to or in the vicinity of the energy converter and are configured to reflect the energy beam of the energy transmission unit at least partially, and
one or more optical markers which, due to their mechanical shape, color(s), printing with patterns and/or digital codes, reflectors (static or modulatable) and/or, due to the use of light sources (invisible or visible spectrum), are configured to identify a location, orientation and/or position of the energy receiving unit in the space by a camera of the energy transmission unit.

11. The energy receiving unit according to claim 10, wherein a plurality of reflectors are arranged surrounding the energy converter in a circular manner.

12. The energy receiving unit according to claim 10, wherein the reflector(s) is/are configured such that the reflectance thereof can be electrically controlled or modulated.

13. The energy receiving unit according to claim 12, wherein the reflector(s) is/are adapted as controllable LCD elements for controlling or modulating the reflectance thereof.

14. The energy receiving unit according to claim 12, further having an element adapted to control or modulate the reflectance of the reflectors.

15. A system having an energy transmission unit according to claim 1 and an energy receiving unit according to claim 10, wherein the energy transmission unit and the energy receiving unit are or can be spatially aligned relative to one another in such a way that energy can be transmitted by the energy transmission unit to the energy receiving unit by means of an energy beam generated by the energy transmission unit, which is received by the energy receiving unit and converted into electrical energy.

16. A method for transmitting energy between an energy transmission unit and an energy receiving unit, which are or can be spatially aligned relative to one another, comprising the following steps of:
capturing at least the following information by a camera of the energy transmission unit:
presence and position of markers or reflectors of the energy receiving unit,
position of the eyes of humans and/or animals,
checking the presence of the markers or reflectors of the energy receiving unit and a sufficient safety distance between the position of an energy converter of the energy receiving unit and the eyes of humans and/or animals as required criteria,
provided that these required criteria are met, aligning a radiation source of the energy transmission unit to a detected position of the energy receiving unit and activating the radiation source, such that an energy beam is generated by the radiation source,
receiving energy of the energy beam generated by the radiation source by the energy receiving unit (2),
converting the received energy into electrical energy by means of the energy converter of the energy receiving unit.

17. The method according to claim 16, wherein checking of the required criteria is continued as long as a sufficient number of criteria are not met.

18. The method according to claim 16, wherein checking of the required criteria is continued periodically at a predefined time interval, wherein the time interval or a time criterion is predefined in such a way that
a) the positions of objects, humans or animals have not yet significantly altered, and/or
b) due to the shortness of time, no hazardous exposure, in particular of the eyes, can take place in the energy beam (1.4.1).

19. The method according to claim 16, wherein after activating the radiation source, the latter is deactivated or the power thereof is reduced, if checking of the required criteria reveals that a sufficient number of criteria are no longer met.

20. The method according to claim 16, wherein the energy beam is converted or shaped into a shaped energy beam by means of a unit for beam shaping.

21. The method according to claim 16, wherein a direction of the energy beam or of the shaped energy beam is controlled by a mechanical actuator and/or by non-mechanical control means.

22. The method according to claim 16, wherein energy of the energy beam is reflected by reflectors of the energy receiving unit and these reflections are received and evaluated by a receiver of the energy transmission unit.

23. The method according to claim 22, wherein the reflectors of the energy receiving unit modulate the reflections and the receiver works as a demodulator and receives and demodulates the modulated reflections.

24. The method according to claim 22, wherein a direction of the energy beam or of the shaped energy beam is continually readjusted based on the evaluated reflections.
